(19) United States
(12) Patent Application Publication
(10) Pub. No.: US 2024/0168791 A1
(43) Pub. Date: May 23, 2024

(54) SYSTEM AND METHOD FOR SPOT LIFE CYCLE MANGEMENT

(71) Applicant: PROFISEA LABS LTD, Hod Hasharon (IL)

(72) Inventors: Vladislav SHULMAN, Hod Hasharon (IL); Oleg MATSKULA, Rodzil (UA)

(21) Appl. No.: 18/280,249

(22) PCT Filed: Feb. 22, 2022
(86) PCT No.: PCT/IB2022/051542

§ 371 Date: Sep. 4, 2023

Related U.S. Application Data
(60) Provisional application No. 63/156,376, filed on Mar. 4, 2021.

(51) Int. Cl. G06F 9/455; G06F 9/50

(52) U.S. Cl. CPC G06F 9/45558; G06F 9/5077

(57) ABSTRACT

Managing instances in a virtual networking environment in a cloud by monitoring the state of a first instance, replacing the first instance with a second instance if the state of the first instance is to-be-replaced, and replacing information related to the first instance with information related to the second instance in a plurality of entities which are in communication with the first instance.

### FIELD

The invention relates to the field of cloud computing in general, and in particular to managing the life cycle of spot instances.

### BACKGROUND

Cloud computing is a model of allocating on demand computer system resources such as data storage, networking capacity and computing power without a direct active management of the customer and without the need to purchase, store and manage the physical equipment. Cloud computing providers own and manage the actual resources and they allocate resources to customers for a known price based on the resource type, size and operating system.

The provider's computing resources are pooled to serve multiple consumers using a multi-tenant model, with different physical and virtual resources dynamically assigned and reassigned according to consumer demand.

Cloud providers (e.g., Microsoft Azure, Amazon Web Services, Google Cloud Platform and the like) often offer several types of resources pricing: (a) On-demand resource using a pay-as-you-go pricing approach; (b) “pre-emptible”-Spot Instance—using a bid pricing; and (c) reserved instances—provide a capacity reservation for committed level of usage with a discount billing.

In the On-demand model, the customer pays only for the individual services he consumes and computing instances he uses for as long they are used at a fixed price. Once the customer stops using the resources, there are no additional costs or termination fees. The On-demand type of resource is guaranteed to the customer until deallocated.

For On-demand type of resource the price is charged for on a per hour usage. the customer may control the resource consumption by shutting down the resource when it's not required and turning it on when needed. Several scheduling tools exist on the market that can schedule only On-demand instances and can not schedule spot instances.

The price of a resource may also depend on the commitment of the customer for a long period of usage (1-3 years) and on the payment option (upfront vs monthly payment) where the customer basically purchases the computing instance without being able to deallocate it during this period. For committed resources the price will be charged regardless of whether it was used or not.

In a “spot” or “pre-emptible” resource (spot instance) model, Spot Instances are typically made available only until another customer is willing to pay more for the instance, resulting in a possible force deallocation of the spot instance (a “Spot Kill” or “pre-emption”) at any time.

Using cloud computing, an organization converts capital expenses to operational expenses and should manage the cloud resources wisely to minimize unnecessary expense. The operational expenses depend on several characteristics of the resource provided by the cloud provider. The characteristics that may impact the cost of a resource include for example the period for which the resource is requested—a longer period usually implies a lower price, and the stability of the resource—a more stable resource usually implies a higher price. A stability of a resource is expressed by the probability of it being available to the customer such that a more stable resource is more likely to be available to the customer over time.

The stability of a resource also depends on the allocation scheme used by the cloud provider that may be an on-demand scheme implying a guaranteed resource or a Spot Instance scheme implying a not guaranteed, temporary resource which is less stable but much cheaper than an on-demand resource.

For example, Amazon EC2 offers Spot Instances at up to a 90% discount compared to On-Demand prices. According to Amazon “Spot Instances may be used for various stateless, fault-tolerant, or flexible applications such as big data, containerized workloads, Cl/CD, web servers, high-performance computing (HPC), and test & development workloads”.

In another example, Google cloud provides preemptible instance that can be created and run at a much lower price than normal instances. However, they state that the cloud provider Compute Engine might stop (preempt) these instances if it requires access to those resources for other tasks. According to Google “If your apps are fault-tolerant and can withstand possible instance preemptions, then preemptible instances can reduce your Compute Engine costs significantly”.

When a spot is reclaimed (in the Amazon WEB Services (AWS) account, in a? virtual private cloud (VPC) or in any smaller subset group of assets) and another spot may be allocated to replace the lost spot, the impact to the virtual networking environment may be significant when information associated only with the lost spot, that is no longer valid, and not with the new allocated spot, is used by other resources. In this case, the functionality of the virtual networking environment may be substantially affected and therefore spot instances are mostly used in stateless applications.

### SUMMARY

There is provided, in accordance with an embodiment of the invention, a spot life cycle manager system to manage instances in a virtual networking environment in a cloud, the system implemented on at least one processor and memory. The system includes an instance monitor to determine a status of a first instance, an instance manager to store relevant information related to the first instance, terminate the first instance, and use the relevant information to create a second instance, if the status of the first instance is to-be-replaced and an environment manager to update a plurality of entities with details of the second instance, replacing details of the first instance.

Additionally, in accordance with an embodiment of the invention, the first instance is on-demand instance or spot instance, and the second instance is on-demand instance or spot instance.

Moreover, in accordance with an embodiment of the invention, the instance monitor includes an instance state inspector to proactively monitor the status of the first instance using the cloud API and an instance event handler to receive from the cloud events related to the first instance.

Furthermore, in accordance with an embodiment of the invention, the instance manager includes a machine image creator to create an image of the first instance, the image includes information enabling creating the second instance similar to the first instance, an instance terminator to terminate the first instance and an instance allocator to create the second instance using the image of the first instance.

Still further, in accordance with an embodiment of the invention, information in the image includes a type, a list of volumes, a list of network interfaces and a list of security groups.

Additionally, in accordance with an embodiment of the invention, the environment manager includes an environment analyzer to identify relevant entities which are in communication with the first instance and an environment updater to replace information related to the first instance with information related to the second instance in the relevant entities.

Moreover, in accordance with an embodiment of the invention, the entities include external elements which are in communication with the virtual networking environment.

Additionally, in accordance with an embodiment of the invention, the external elements include a scheduler.

Furthermore, in accordance with an embodiment of the invention, the entities comprise any combination of load balancer, cloud domain name system, web service, network element, volume, database, and database cluster.

Still further, in accordance with an embodiment of the invention, the spot life cycle manager system can be configured to operate on a subset of instances of the virtual networking environment.

There is provided, in accordance with an embodiment of the invention, a method for managing instances in a virtual networking environment in a cloud, the method includes monitoring a state of a first instance, replacing the first instance with a second instance if the state of the first instance is to-be-replaced and replacing information related to the first instance with information related to the second instance in a plurality of entities which are in communication with the first instance.

Additionally, in accordance with an embodiment of the invention, the first instance is an on-demand instance, or a spot instance and the second instance is an on-demand instance or a spot instance.

Moreover, in accordance with an embodiment of the invention, the replacing step includes creating an image of the first instance, terminating the first instance and creating a second instance based on the image.

Furthermore, in accordance with an embodiment of the invention, the replacing step includes updating information in external entities located outside the virtual networking environment.

Still further, in accordance with an embodiment of the invention, the external entities include a scheduler.

Additionally, in accordance with an embodiment of the invention, the entities include any combination of load balancers, cloud domain name systems, web services, network elements, volumes, databases and clusters.

Moreover, in accordance with an embodiment of the invention, the image includes a type, a list of volumes, a list of network interfaces and a list of security groups.

Furthermore, in accordance with an embodiment of the invention, the replacing step operates on a subset of instances.

### BRIEF DESCRIPTION OF THE DRAWINGS

The invention will now be described in relation to certain examples and embodiments thereof with reference to the following illustrative drawing figures so that it may be more fully understood. In the drawings:

FIG. 1 is a schematic illustration of an eco-system where a spot life cycle manager system constructed and operative in accordance with embodiments of the present invention may be operating;

FIG. 2 is a schematic illustration of a flow implemented by a spot life cycle manager system constructed and operative in accordance with embodiments of the present invention;

FIG. 3 is a schematic illustration of spot life cycle manager system constructed and operative in accordance with an embodiment of the present invention;

FIG. 4 is a schematic illustration of an instance monitor part of spot life cycle manager of FIG. 2 constructed and operative in accordance with an embodiment of the present invention;

FIG. 5 is a schematic illustration of an instance manager part of spot life cycle manager of FIG. 2 constructed and operative in accordance with an embodiment of the present invention; and

FIG. 6 is a schematic illustration of an environment manager part of spot life cycle manager of FIG. 2 constructed and operative in accordance with an embodiment of the present invention.

It will be appreciated that for simplicity and clarity of illustration, elements shown in the drawing figures have not necessarily been drawn to scale. For example, the dimensions of some of the elements may be exaggerated relative to other elements for clarity. Further, where considered appropriate, reference numerals may be repeated among the drawing figures to indicate the same or analogous elements.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Embodiments of the invention provide systems and methods for managing the life cycle of spot instances. Embodiments of the invention enable the replacement of an instance automatic and transparent to the environment and to its users and therefore enable the usage of spot instances in both stateless and stateful virtual networking environment in the cloud.

Keeping the replacement transparent may also enable managing all type of instances in the environment in a similar manner, without the need to distinguish between on-demand and spot instances. For example, it may be possible to schedule all instances, including spot instances, in scheduling systems, use spot instances in clusters and the like.

The replacement of instances to spot instances may reduce the cost of operation since spot instances are much cheaper than standard instances. In addition, the price of spot instances themselves may vary over time and a more expensive spot may be replaced by a cheaper one. The ability to schedule spot instances may further help reducing the cost of operation since the cloud provider charges only working instances. The replacement of a spot instance with an on-dement instance may also be sometimes useful.

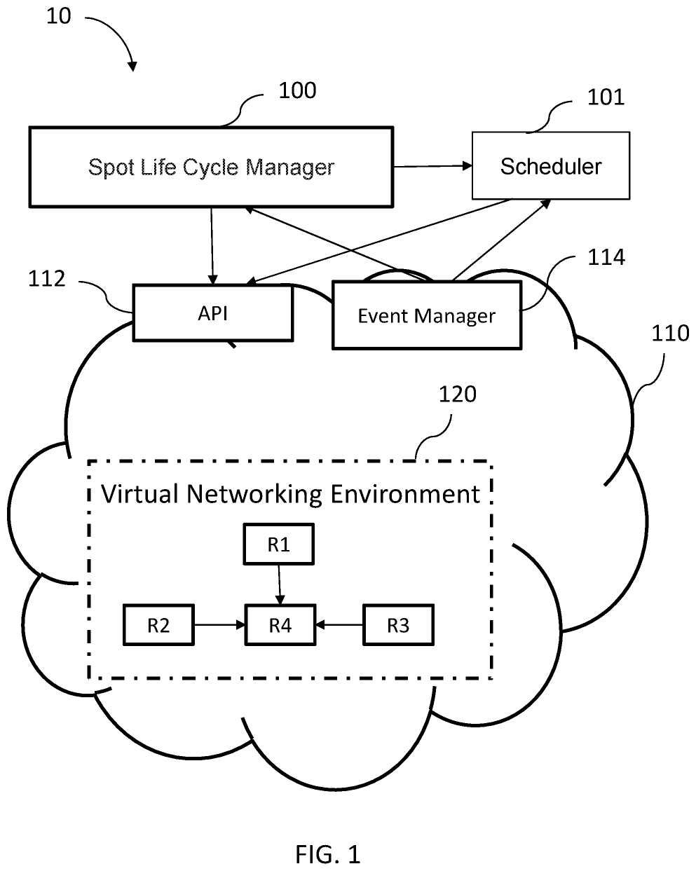

FIG. 1, to which reference is now made, is a schematic illustration of an eco-system 10 where spot life cycle manager 100 may be installed. Eco-system 10 comprises a virtual networking environment 120, operating on a cloud 110 (provided by any cloud provider); and a spot life cycle manager 100, handling instances in virtual networking environment 120 and optionally communicating with scheduler 101 and other optional external entities operating with instances in virtual networking environment 120.

Virtual networking environment 120 may comprise computing, networking, storage, and other associated technology resources. Virtual networking environment 120 may be an account, a virtual private cloud (VPC), a group of instances and the like. Virtual networking environment 120 comprises 4 instances providing resources: R1, R2, R3 and R4 where instances R1, R2 and R3 uses some functionalities provided by instance R4. It may be appreciated that the connectivity between the difference instances Ri, their number, and their type in virtual networking environment 120 may vary and may include any number and types of instances, connected in any manner to any number of other instances. Each resource R in virtual networking environment 120 may be an on-demand instance or a spot.

Cloud 110 may provide at least an API 112 through which the customer and external entities operating with instances in virtual networking environment 120 may access, operate, and manage the resources on virtual networking environment 120 and an events manager 114 through which cloud 110 may inform the customer and the external entities of events related to instances Ri in virtual networking environment 120.

Spot life cycle manager 100 may connect with virtual networking environment 120 through API 112 and event manager 114 and may automatically, seamlessly, and transparently replace on-demand instances and spot instances in virtual networking environment 120 with on-demand or spot instances with minimum impact on the ongoing functionality of virtual networking environment 120 and its users. Spot life cycle manager 100 may also be in communication with external entities like scheduler 101 that communicate with entities in virtual networking environment 120.

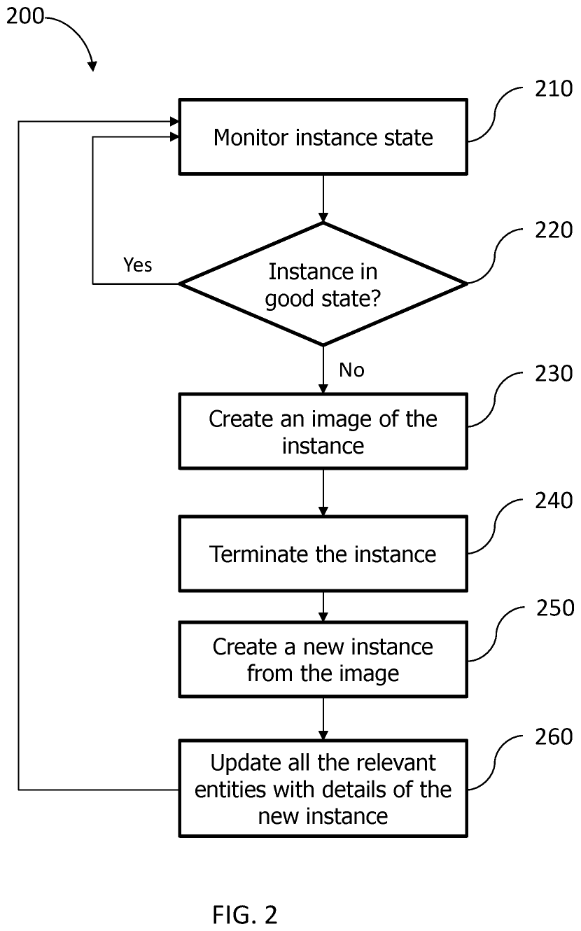

Spot life cycle manager 100 may proactively ask every configurable amount of time for the state of each instance R in virtual networking environment 120 and may receive events related to the status of instances R from virtual networking environment 120 located on cloud 110. Spot life cycle manager 100 may determine the state of each instance R as “good” or “to-be-replaced” and if or when the state of an instance R is “to-be-replaced” (e.g., a spot instance is about to be terminated; an on-demand instance can be replaced by a spot etc.) spot life cycle manager 100 may apply a soft land procedure for the instance that is in a “to-be-replaced” state described in detail with respect to FIG. 2 herein below.

Scheduler 101 may schedule instances R in virtual networking environment 120.

Scheduler 101 may configure custom start and stop schedules for instances R operating in virtual networking environment 120 to reduce operational costs. Scheduling the working slots of instances R may further reduce the cost of operation of virtual networking environment 120.

FIG. 2, to which reference is now made, is a flow 200 describing the steps that spot life cycle manager 100 may perform to manage each instance Ri in virtual networking environment 120. It may be appreciated that spot life cycle manager 100 may concurrently monitor all instances R and perform the steps of flow 200 on any subset of instances in virtual networking environment 120, covering part or all instances.

In step 210, spot life cycle manager 100 may continuously inspect and examine the status of instance Ri in virtual networking environment 120 and determine its status as “good” or “to-be-replaced”.

In step 220, spot life cycle manager 100 may determine if the status of instance Ri in virtual networking environment 120 is “good” (e.g., the instance is not about to be terminated). If the status of instance Ri is “good”, spot life cycle manager 100 may return to step 210 to continue monitoring it.

If the status of instance Ri is “to-be-replaced”, spot life cycle manager 100 may proceed to step 230 where it may create a system image of instance Ri.

In step 240 spot life cycle manager 100 may terminate instance Ri and in step 250 spot life cycle manager 100 may create a new instance, R-new, from the image created in step 230 and may continue to step 260 where spot life cycle manager 100 may update all the relevant entities (internal elements such as various other instances R operating in virtual networking environment 120, and external elements such as scheduler 101 communicating with instances R in virtual networking environment 120) with the details of the new created spot instance R-new, replacing the details of old instance Ri. Virtual networking environment 120 and external may perceive the replacement of instance Ri with R-new as no more than a restart of instance

Ri.

For example, if R4 (FIG. 1) is a spot instance that is about to be terminated, spot life cycle manager 100 may create a system image of R4, create a new spot instance R5 based on the created image, terminate R4, and replace the information related to R4 in instances R1, R2 and R3, and in scheduler 101 with the information related to R5.

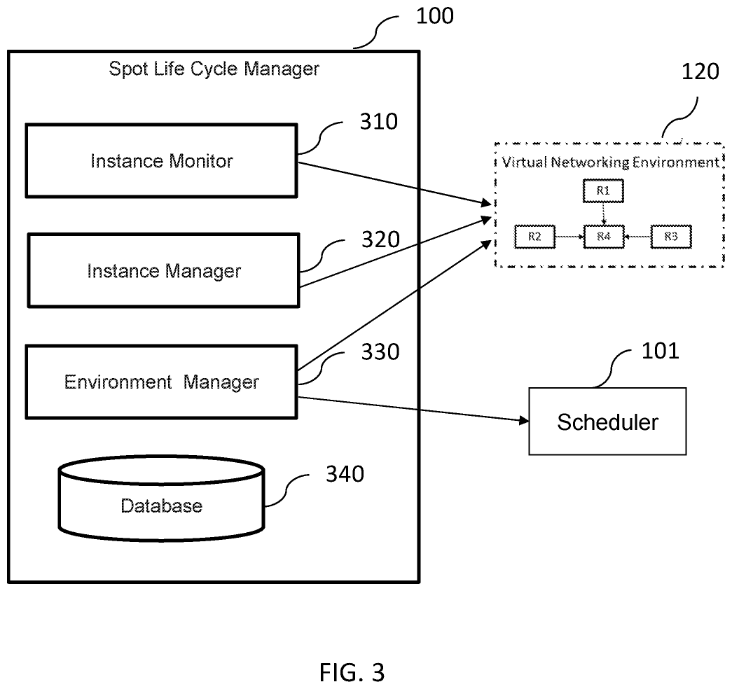

FIG. 3, to which reference is now made, is a schematic illustration of spot life cycle manager 100 constructed and operative in accordance with an embodiment of the present invention. Spot life cycle manager 100 may monitor the state of instances R in virtual networking environment 120, handle each instance based on its state and if replaced, update virtual environment 120 and scheduler 101 with which it communicates. Spot life cycle manager 100 comprises an instance monitor 310; an instance manager 320; an environment manager 330 and a database 340.

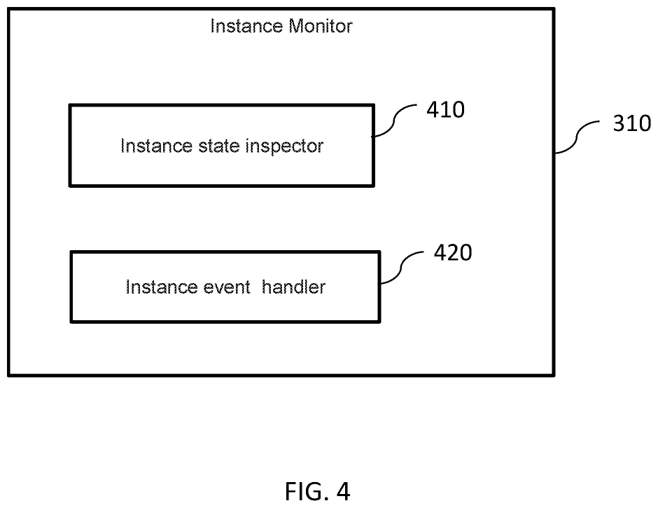

FIG. 4, to which reference is now made, is a schematic illustration of instance monitor 310 constructed and operative in accordance with an embodiment of the present invention. Instance monitor 310 may inspect the status of the instance Ri in virtual networking environment 120 to evaluate its state. Instance monitor 310 comprises an instance state inspector 410 and an instance event handler 420.

Instance state inspector 410 may check every configurable amount of time (e.g., 30 seconds) the status of instance Ri using cloud native API 112. Instance state inspector 410 may also evaluate the price condition of spot instance Ri and determine if the price is adequate, too low, or too high, evaluate the chance of it being terminated by cloud 110 and update its status accordingly.

Instance event handler 420 may handle events related to Ri, such as for example spot instance interruption and any other event that may help assessing the status of instance Ri, received via events manager 114 of cloud 110.

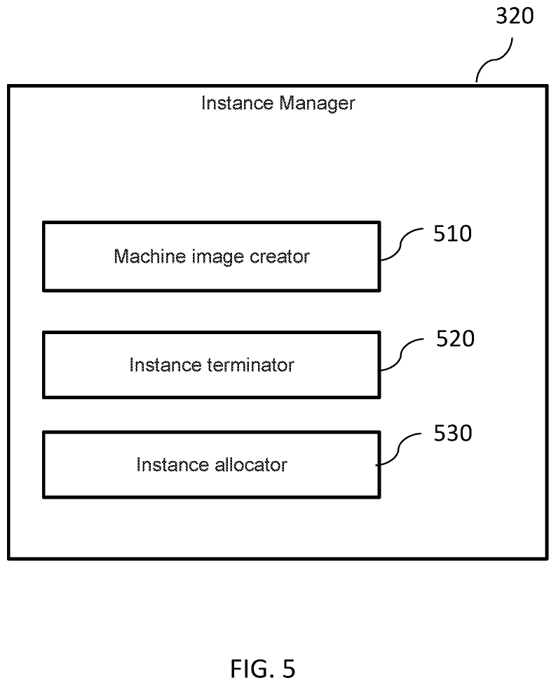

FIG. 5, to which reference is now made, is a schematic illustration of instance manager 320 constructed and operative in accordance with an embodiment of the present invention.

Instance manager 320 may be responsible to store the information of all spot instances R located in virtual networking environment 120 in database 340. When the status of an instance Ri is “to-be-replaced”, instance manager 320 may prepare a soft land for instance Ri, terminate it when needed and create a new spot instance R-new, identical to the terminated instance as described in flow 200. Instance manager 320 comprises a machine image creator 510; an instance terminator 520 and an instance allocator 530.

Machine image creator 510 may create an image of instance Ri that may include information required to launch a new similar instance R-new with the needed configuration to replace instance Ri. Machine image creator 510 may store information related to the instance such as its type, volumes, network interfaces, security groups, and the like.

In Amazon cloud for example, machine image creator 510 may create an Amazon Machine Image (AMI) that includes one or more Amazon Elastic Block Store (Amazon EBS) snapshots, or, for instance-store-backed AMIs, a template for the root volume of the instance (for example, an operating system, an application server, and applications) and the like.

The AMI created by image creator 510 may also include a list of launch permissions that control which AWS accounts can use the AMI to launch instances and a block device mapping that specifies the volumes to attach to the new instance R-new when launched. Machine image creator 510 may create and store all the information related to an instance Ri from which a new similar instance R-new may be launched to replace instance Ri with minimal impact on virtual networking environment 120.

Instance terminator 520 may activate machine image creator 510 to create and store an image of an instance Ri in database 340. Instance terminator 520 may detach any volumes attached to instance Ri, which is to be terminated and may store information needed to reattach them to a new instance R-new. After having the needed information stored in database 340, instance terminator 520 may terminate instance Ri. If the instance is not terminated by cloud 110, instance terminator 520 may revert instance Ri to its original state and deregister the AMI so that virtual networking environment 120 may continue its functionality with no change.

Instance allocator 530 may allocate a new spot instance (or an on-demand instance) R-new, like instance Ri that is about to be replaced. If a spot instance with a type identical to instance Ri is not available in cloud 110, instance allocator 530 may allocate a new spot instance R-new with the closest type. If there is no available spot in cloud 110, instance allocator 530 may allocate an on-demand computing instance instead of a spot instance. It may be appreciated that the on-demand computing instance may be replaced to a spot instance by spot life cycle manager 100 later, when a suitable spot instance becomes available in cloud 110.

Instance allocator 530 may create the configuration of a new instance R-new using the image of the terminated instance Ri stored in database 340. Instance allocator 530 may attach volumes previously attached to the terminated instance Ri to the new instance R-new and may update all relevant assets in the eco-system with the details of the new instance R-new completing a seamless instance replacement in virtual networking environment 120.

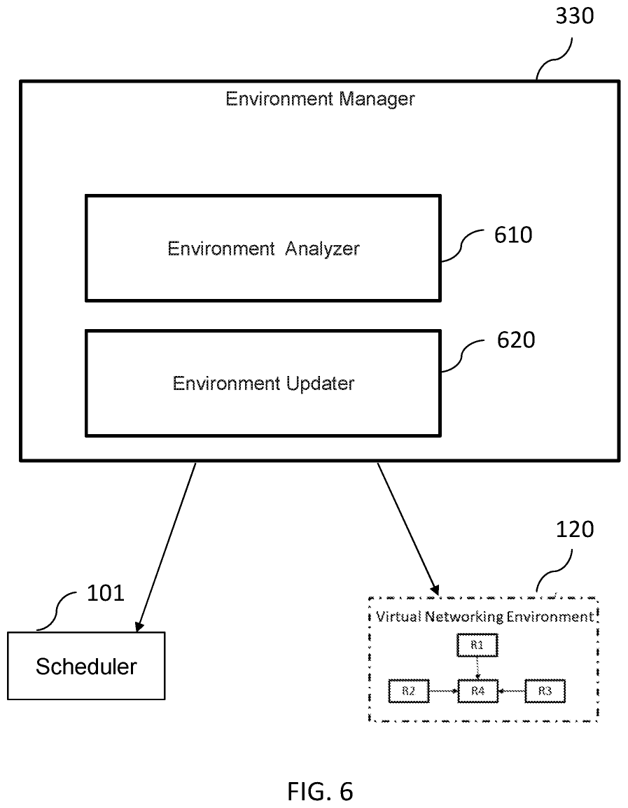

FIG. 6, to which reference is now made, is a schematic illustration of environment manager 330 constructed and operative in accordance with an embodiment of the present invention. Environment manager 330 may analyze the connectivity between internal entities (operating in virtual networking environment 120) and external entities (communicating from outside virtual networking environment 120 with entities R in virtual networking environment 120) and may automatically discover all entities that might possibly be affected when an instance Ri is replaced in virtual networking environment 120.

Environment manager 330 comprises an environment analyzer 610 and an environment updater 620.

Environment analyzer 610 may analyze all the internal entities used in virtual networking environment 120 and external entities communicating with virtual networking environment 120 (such as scheduler 101) and identify all entities that may be affected when an instance Ri is terminated. Such entities may be for example Load Balancers; Cloud Domain Name Systems (DNS); web service (Route 53); various network elements, clusters; external schedulers and the like.

Environment updater 620 may update information related to the analyzed entities that may be affected when the environment changes in database 340. When an instance Ri is terminated and a new instance R-new is allocated, environment updater 620 may update the relevant information in the various entities.

Environment updater 620 may update internal entities R in the environment with the new information associated with new instance R-new such that the replacement may be perceived in virtual networking environment 120 as a restart of an existing instance Ri and not like an introduction of a completely new instance R-new.

Environment updater 620 may also update information in external entities such as scheduler 101 to maintain any scheduling scheme for the various instances R, configured on scheduler 101 according to pre-defined or recommended scheduling policies. Environment updater 620 may update relevant scheduling systems (e.g., scheduler 101) with the details of new instance R-new so that they may handle the scheduling of any new instance R-new according to the same policy that was applied to the original computing instance Ri, it replaced. It may be noted that environment updater 620 may handle changes related to the ID of an instance that may change during spotting or recovery.

Environment updater 620 may also update all the relevant information related to network interfaces and volume attributed to ensure that they will survive and will not disappear when instance Ri is terminated.

Database 340 may be used to store all relevant information related to instances R in virtual networking environment 120 and additional information related to virtual networking environment 120 itself and to the connectivity between instances R and external entities. Database 340 may be configured to perform a backup every configurable amount of time to keep the data accurate.

Database 340 may also store information related to the history of a resource in virtual networking environment 120. The information may include all the instances that were used by the resource (the resource could start running on an on-demand instance that is later replaced by a spot instance that may be further replaced numerous times by other spot instances) and for each instance, the time it was created and/or terminated, its ID, its cost, when it was scheduled to run, and the like.

Spot life cycle manager 100 may display the history of the resources in networking environment 120 to a user with relevant information and statistics (all the servicing instances, the operating time of each instance, the cost and the like). Spot Life Cycle Manager 100 may use the information related to the usage of each resource and provide scheduling recommendation to further reduce the cost of operation in the cloud. For example, if a resource R is never used in the weekends, spot life cycle manager 100 may recommend not to schedule resource R to operate on the weekends.

Using spot life cycle manager 100 to manage the life cycle of spot instances in virtual networking environment 120 enable scheduling short term resources operating on spot instances since the resource maintains its continuity regardless of the instance on which it operates.

In some cases, customers may wish to install their own database cluster on instances of cloud 110. It is a common practice to install the managers of the database on highly available instances R in cloud 110 and the nodes on standard on-demand instances R. In this case, spot life cycle manager 100 may be configured to manage the nodes (not the masters) such that a portion (e.g., 60%) of the nodes may be replaced by spot instances while the other nodes remain on-demand instances. Spot life cycle manager 100 may update the entire cluster (as described herein above) when an instance of the cluster is replaced while avoiding the case of concurrent replacement of all the nodes in the cluster at once (some nodes remain on on-demand instances).

It may be appreciated that in current cloud environment a seamless replacement of spot instances can be done only in a stateless environment where the details of a spot instance that may be replaced are not used by other internal or external entities in the environment. Embodiments of the present invention provide transparent replacement of spot instances also in stateful environments, which is not otherwise available.

It may be appreciated by the person skilled in the art that the different parts of the system, shown in the different figures and described herein, are not intended to be limiting and that the system may be implemented by more or less parts, or with a different arrangement of parts, or with one or more processors performing the activities of the entire system, or any combination thereof. It may also be appreciated by the person skilled in the art that the steps shown in the different flows described herein are not intended to be limiting and that the flows may be practiced with more or less steps, or with a different sequence of steps, or any combination thereof.

Unless specifically stated otherwise, as apparent from the following discussions, it is appreciated that throughout the specification discussions utilizing terms such as “analyzing”, “processing,” “computing,” “calculating,” “determining,” “detecting”, “identifying” or the like, refer to the action and/or processes of a computer or computing system, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A spot life cycle manager system to manage instances in a virtual networking environment in a cloud, the system implemented on at least one processor and memory, the system comprising:
an instance monitor to determine a status of a first instance;
an instance manager to store relevant information related to the first instance, terminate the first instance, and use the relevant information to create a second instance, if a status of the first instance is to-be-replaced; and
an environment manager to update a plurality of entities with details of the second instance, replacing details of the first instance.

2. The spot life cycle manager system of claim 1 wherein the first instance is one of: on-demand instance and spot instance and the second instance is one of: on-demand instance and spot instance.

3. The spot life cycle manager system of claim 1 wherein the instance monitor comprises:
an instance state inspector to proactively monitor the status of the first instance using the cloud API; and
an instance event handler to receive from the cloud events related to the first instance.

4. The spot life cycle manager system of claim 1 wherein the instance manager comprises:
a machine image creator to create an image of the first instance, the image comprises information enabling creating the second instance similar to the first instance;
an instance terminator to terminate the first instance; and
an instance allocator to create the second instance using the image of the first instance.

5. The spot life cycle manager system of claim 4 wherein information in the image comprises a type, a list of volumes, a list of network interfaces and a list of security groups.

6. The spot life cycle manager system of claim 1 wherein the environment manager comprising:
an environment analyzer to identify relevant entities which are in communication with the first instance; and
an environment updater to replace information related to the first instance with information related to the second instance in the relevant entities.

7. The spot life cycle manager system of claim 6 wherein the entities comprise external elements which are in communication with the virtual networking environment.

8. The spot life cycle manager system of claim 7 wherein the external elements comprise a scheduler.

9. The spot life cycle manager system of claim 6 wherein the entities comprise any combination of: load balancer, cloud domain name system, web service, network element, volume, database, and database cluster.

10. The spot life cycle manager system of claim 1 configured to operate on a subset of instances of the virtual networking environment.

11. A method for managing instances in a virtual networking environment in a cloud, the method comprising:
monitoring a state of a first instance;
replacing the first instance with a second instance if the state of the first instance is to-be-replaced; and
replacing information related to the first instance with information related to the second instance in a plurality of entities which are in communication with the first instance.

12. The method of claim 11 wherein the first instance is one of: on-demand instance and spot instance and the second instance is one of: on-demand instance and spot instance.

13. The method of claim 11 wherein the replacing comprises:
creating an image of the first instance;
terminating the first instance; and
creating a second instance based on the image.

14. The method of claim 13 wherein the replacing comprises updating information in external entities located outside the virtual networking environment.

15. The method of claim 14 wherein the external entities comprise a scheduler.

16. The method of claim 11 wherein entities comprise any combination of load balancers, cloud domain name systems, web services, network elements, volumes, databases and clusters.

17. The method of claim 13 wherein the image comprises a type, a list of volumes, a list of network interfaces and a list of security groups.

18. The method of claim 11 wherein the replacing operates on a subset of instances.
